(19) United States
(12) Patent Application Publication
(10) Pub. No.: US 2025/0250414 A1
(43) Pub. Date: Aug. 7, 2025

(54) STABILISED, TRANSITION-METAL-CONTAINING PLASTICS COMPOSITIONS, MOULDING COMPOUND OR MOULDED PART AND USE OF A STABILISER COMPOSITION FOR STABILISING TRANSITION METAL-CONTAINING PLASTICS

(71) Applicant: FRAUNHOFER-GESELLSCHAFT ZUR FÖRDERUNG DER ANGEWANDTEN FORSCHUNG E.V., München (DE)

(72) Inventors: Heiko ASCHENBACH, Darmstadt (DE); Matthias AHLE, Darmstadt (DE); Elke METZSCH-ZILLIGEN, Darmstadt (DE); Rudolf PFAENDNER, Darmstadt (DE)

(73) Assignee: FRAUNHOFER-GESELLSCHAFT ZUR FÖRDERUNG DER ANGEWANDTEN FORSCHUNG E.V., München (DE)

(21) Appl. No.: 18/855,807

(22) PCT Filed: Apr. 12, 2023
(86) PCT No.: PCT/EP2023/059563

§ 371 Date: Oct. 10, 2024

(30) Foreign Application Priority Data
Apr. 12, 2022 (DE) 10 2022 203 654.9

(51) Int. Cl. C08K 5/053; C08K 5/12; C08K 5/13; C08K 5/25

(52) U.S. Cl. CPC C08K 5/053; C08K 5/12; C08K 5/13; C08K 5/25

(57) ABSTRACT

The present invention relates to a method for stabilising transition-metal-containing plastics against oxidative, thermal and/or actinic degradation, in which method at least one sugar alcohol, in combination with at least one phenolic antioxidant, is introduced into a transition-metal-containing plastic. The method is performed in such a way that the resulting plastics composition, with additives introduced, has a total content of transition metals of at least 10 ppm (wt/wt). The present invention also relates to an accordingly produced, stabilised plastics composition, moulding compounds and moulded parts which can be produced from said composition and use of a stabiliser combination made of at least one sugar alcohol and at least one phenolic antioxidant for stabilising transition-metal-containing plastics.

The present invention relates to a method for stabilizing transition-metal-containing plastics against oxidative, thermal and/or actinic degradation, in which at least one sugar alcohol is introduced into a transition-metal-containing plastic in combination with at least one phenolic antioxidant. The method is carried out here in such a way that the resulting additivized plastics composition has a total content of transition metals of at least 10 ppm (wt./wt.). The present invention also relates to a correspondingly produced, stabilized plastics composition, to molding compounds or molded parts which may be produced therefrom, and to the use of a stabilizer combination of at least one sugar alcohol and at least one phenolic antioxidant for stabilizing transition-metal-containing plastics.

Organic materials such as plastics are subject to aging processes that ultimately lead to a loss of the desired properties, such as the mechanical characteristic values. This process, called autoxidation, leads to changes in the polymer chain, such as in the molecular weight and/or to the formation of new chemical groups, starting from radical chain cleavages by mechanochemical processes or by UV radiation in the presence of oxygen. Stabilizers are therefore used to prevent or at least delay this aging. Important representatives of stabilizers are antioxidants that interfere with the radicals formed during autoxidation and thus interrupt the degradation process. A distinction is generally made between primary antioxidants, which may react directly with oxygen-containing free radicals or C radicals, and secondary antioxidants, which react with intermediately formed hydroperoxides (see C. Kröhnke et al. Antioxidants in Ullmann's encyclopedia of industrial chemistry, Wiley-VCH Verlag, Weinheim 2015). Typical representatives of primary antioxidants are, for example, phenolic antioxidants, amines, but also lactones. Classes of secondary antioxidants are phosphorus compounds such as phosphites and phosphonites, but also organo-sulfur compounds such as thioesters, thoethers and disulfides. Typically, primary and secondary antioxidants are often combined in practice, resulting in a synergistic effect.

Methods for stabilizing plastics or plastic recyclates are known from patent applications WO 2020/083740 and WO 2019/063550, in which alditols may be used as co-stabilizers under certain circumstances. However, the plastics formulations described are not described as containing transition metals.

US 2003/2363250 describes polymers containing transition metals for agricultural film applications, which may also contain hydroxycarboxylic acids such as erythritolic acid, arabinolic acid and mannitolic acid. Since these are sugar acids, they are structurally different from the alditols according to the invention, and there are no indications of a metal-deactivating effect. In addition, a polymer-degrading effect is sought, i.e., the opposite of the present invention.

The presence of transition metals in a plastics mixture poses a challenge when stabilizing plastics. Transition metals may catalyze the auto-oxidation process and thus lead to accelerated oxidative damage of a polymer. In order to prevent or reduce the influence of transition metals, so-called metal deactivators are therefore used in plastics formulations (Z. Osawa, Role of metals and metal-deactivators in polymer degradation, Polymer Degradation and Stability (1988), 20(3-4), 203-36), which often require a complex synthesis process compared to conventional antioxidants.

The object of the present invention was therefore to provide an effective stabilization of transition-metal-containing plastics which is easily accessible and therefore particularly cost-effective.

This object is achieved with the features of the independent claims. The respective dependent claims describe advantageous developments.

In a first aspect, the present invention relates to a method for stabilizing plastics containing at least one transition metal against oxidative, thermal and/or actinic degradation, in which at least one sugar alcohol (component (A)) and at least one phenolic antioxidant (component (B)) is introduced into the plastic containing at least one transition metal, such that the total content of the transition metals in the resulting plastics composition containing at least one transition metal is at least 10 ppm (wt./wt.). The at least one transition metal is selected here from the group consisting of the metals of groups 6, 7, 8, 9, 10 and 11 of the periodic table.

Surprisingly, it was found that the stabilizer composition used, i.e., the combination of at least one sugar alcohol (component (A)) and at least one phenolic antioxidant (component (B)), leads to significant stabilization of the transition metals contained in the plastics composition. New stabilizer compositions and a new method for stabilizing plastics in particular are proposed, which are highly effective for polymers containing transition metals and are particularly cost-effective compared to the prior art.

Transition-metal-containing plastics are defined here as plastics with a total transition metal content of at least 10 ppm (wt./wt.).

Preferably, a minimum concentration of at least 50 ppm (wt./wt.), more preferably at least 100 ppm (wt./wt.) is to be understood here. Alternatively or in addition to this, it is possible that the total content of the at least one transition metal is a maximum of 10,000 ppm, preferably a maximum of 5,000 ppm, more preferably a maximum of 2,000 ppm, particularly preferably a maximum of 1,000 ppm.

The concentration data for the transition metal content are to be understood here in relation to the resulting plastics composition, i.e., the composition that is produced by incorporating the stabilizer combination into the plastic containing at least one transition metal.

In principle, the transition metal may comprise a metal from atomic number 24 (chromium) to atomic number 79 (gold) (with the exception of the transition metals of groups 3, 4, 5 and 12 of the periodic table, which are not included). Preferred are the transition metals Cr, Mn, Fe, Co, Ni, Cu, Mo; very particularly preferred are Fe, Co, Ni, Cu, Cr, Mn. The plastic contains >10 ppm, preferably >50 ppm, very preferably >100 ppm of transition metal, preferably in ionic form.

Metals of group 6 of the periodic table are also preferably excluded here from the definition of at least one transition metal. Not included in the definition of the term ‘transition metal’, therefore metals of the titanium, vanadium and chromium group are excluded from the calculation of the total content of transition metals.

The ionic metal content in the polymers may be introduced here through contact with metals, e.g., in cables or in coatings, but also through additives such as fillers. In particular, the commonly used fillers from natural sources often contain transition metals. Transition metals may also be incorporated into polymers, for example through additives such as pigments, which contain catalyst residues from production, for example.

According to a preferred embodiment, the at least one sugar alcohol is selected from the group consisting of alditols, cyclitols or mixtures and combinations thereof.

In particular, the alditols usable according to the invention have the following empirical formulas

HOCH₂[CH(OH)]ₙCH₂OH,

R₁—OCH₂[CH(OH)]ₙCH₂OH, or

HOCH₂[CH(OH)]ₙ[CH(OR₁)]CH₂OH
with n=2-6, preferably n=3-5, wherein R₁ is an optionally substituted sugar residue.

The alditols are particularly preferably selected from the group consisting of threitol, erythritol, galactitol, mannitol, ribitol, sorbitol, xylitol, arabitol, isomalt, lactitol, maltitol, altritol, iditol, maltotritol and hydrogenated oligo- and polysaccharides with polyol end groups and mixtures thereof, heptitols and octitols, in particular meso-glyceroallo-heptitol, D-glycero-D-altro-heptitol, D-glycero-D-manno-heptitol, meso-glycero-gulo-heptitol, D-glycero-D-galacto-heptitol (perseitol), D-glycero-D-gluco-heptitol, L-glycero-D-gluco-heptitol, D-erythro-L-galacto-octitol and D-threo-L-galacto-octitol, wherein the at least one alditol is preferably selected from the group consisting of erythritol, mannitol, isomalt, maltitol and mixtures thereof.

Preferred cyclitols that are usable for the purposes of the present invention are selected here from the group consisting of inositol (myo, scyllo-, D-chiro-, L-chiro-, muco-, neo-, allo-, epi- and cis-inositol), 1,2,3,4-tetrahydroxycyclohexane, 1,2,3,4,5-pentahydroxycyclohexane, quercitol, viscumitol, bornesitol, conduritol, ononitol, pinitol, pinpollitol, quebrachitol, ciceritol, quinic acid, shikimic acid and valienol, preferably myo-inositol.

The phenolic antioxidant is selected from the group of
alkylated monophenols, such as 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, linear or branched nonylphenols such as 2,6-dinonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof;
alkylthiomethylphenols, such as 2,4-dioctylthiomethyl-6-tert-butylphenol, 2,4-dioctylthiomethyl-6-methylphenol, 2,4-dioctylthiomethyl-6-ethylphenol, 2,6-didodecylthiomethyl-4-nonylphenol;
hydroquinones and alkylated hydroquinones, such as 2,6-di-tert-butyl-4-methyoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxylphenyl)adipate;
tocopherols, such as for example α-, β-, γ-, 6-tocopherol and mixtures of these (vitamin E) and also tocopherol acetate;
hydroxylated thiodiphenyl ethers, such as 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide;
alkylidene bisphenols, such as 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol, 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert-butyl-4′-hydroxyphenyl)butyrate], bis(3-tert-butyl-4-hydroxy-5-methylphenyl)dicyclopentadiene, bis[2-(3′-tert-butyl-2′-hydroxy-5′-methylbenzyl)-6-tert-butyl-4-methylphenyl]terephthalate, 1,1-bis(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra(5-tert-butyl-4-hydroxy-2-methylphenyl)pentane;
O-, N- and S-benzyl compounds such as 3,5,3′,5′-tetra-tert-butyl-4,4′-dihydroxy dibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate;

hydroxybenzylated malonates, such as dioctadecyl-2,2-bis(3,5-di-tert-butyl-2-hydroxybenzyl)malonate, dioctadecyl-2-(3-tert-butyl-4-hydroxy-5-methylbenzyl)malonate, didodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate;

aromatic hydroxybenzyl compounds, such as 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol;

triazine compounds, such as 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxphenylethyl)-1,3,5-triazine, 1,3,5-tris(3,5-di-tert-butyl-4-hydroyphenylpropionyl)hexahydro-1,3,5-triazine, 1,3,5-tris(3,5-dicyclohexyl-4-hydroxybenzyl)isocyanurate;

benzyl phosphonates, such as dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid;

acylaminophenols, such as 4-hydroxylauranilide, 4-hydroxystearanilide, octyl N-(3,5-di-tert-butyl-4-hydroxyphenyl)carbamate;

esters of β-(3,5-di-tert-butyl-4-hydroxyphenyl)propionic acid with mono- or polyvalent alcohols, for example methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane;

esters of β-(5-tert-butyl-4-hydroxy-3-methylphenyl)propionic acid with mono- or polyvalent alcohols, for example methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octan, 3,9-bis[2-{β-(3-tert-butyl-4-hydroxy-5-methylphenyl)propionyloxy}-1,1-dimethylethyl]-2,4,8,10-tetraoxaspiro[5.5]undecane;

esters of β-(3,5-dicyclohexyl-4-hydroxyphenyl)propionic acid with monovalent or polyvalent alcohols, for example methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane;

esters of (3,5-di-tert-butyl-4-hydroxyphenyl)acetic acid with mono- or polyvalent alcohols, for example methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane;

amides of β-(3,5-di-tert-butyl-4-hydroxyphenyl)propionic acid such as N,N′-bis(3,5-di-tert-butyl-4-hydroxyphenylpropionyl)hexamethylene diamide, N,N′-bis(3,5-di-tert-butyl-4-hydroxyphenylpropionyl)hexamethylene diamide, N,N′-bis(3,5-di-tert-butyl-4-hydroxyphenylpropionyl)hexamethylene diamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1, distributed by Uniroyal);

ascorbic acid (vitamin C).

Particularly preferred phenolic antioxidants are the following structures:

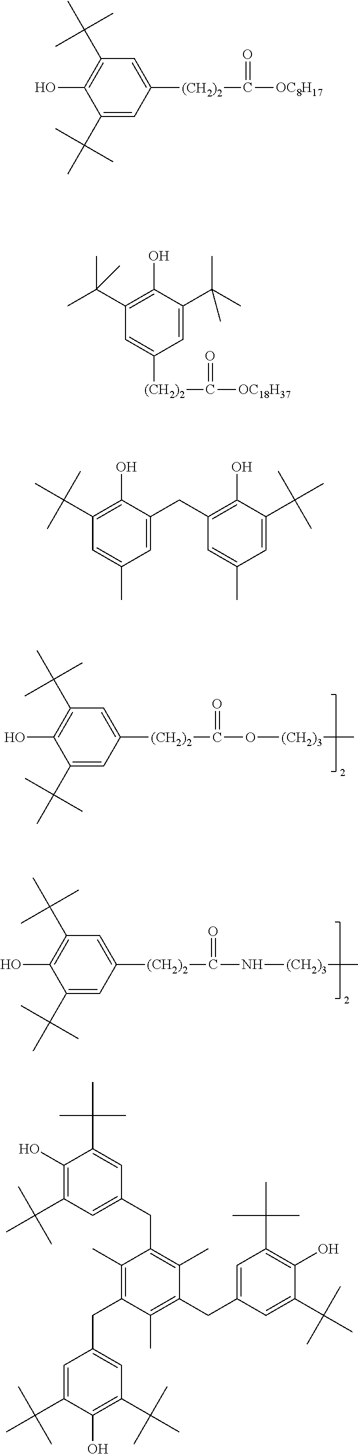

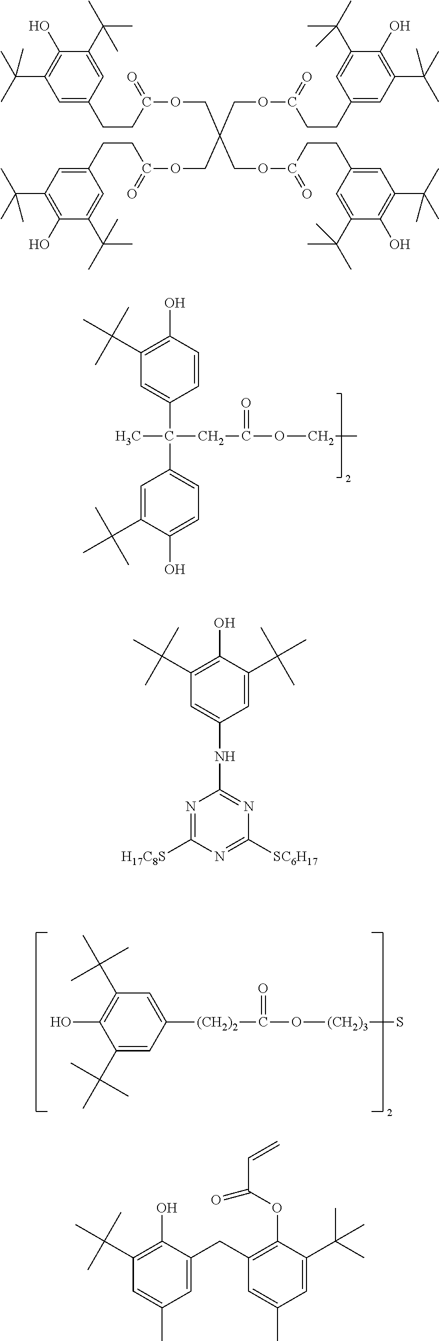

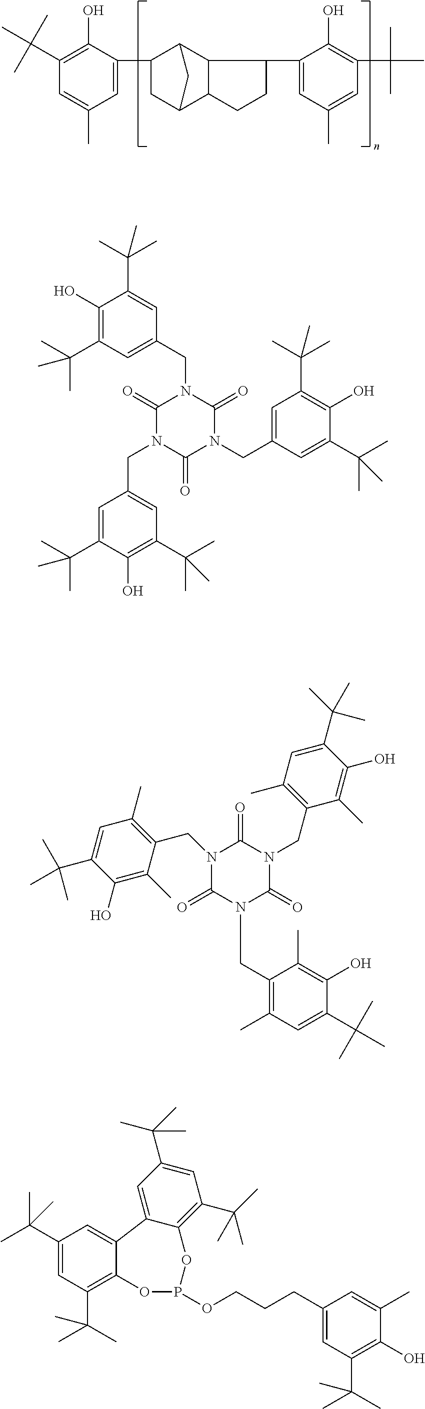

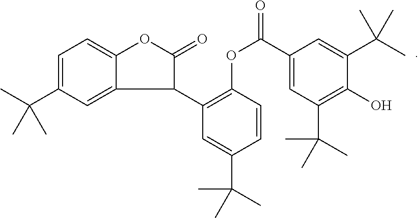 [SMILES: CC(C)(C)c1ccc(OC(=O)c2cc(C(C)(C)C)c(O)c(C(C)(C)C)c2)c(C2C(=O)Oc3ccc(C(C)(C)C)cc32)c1]

Further particularly preferred phenolic antioxidants are based on sustainable raw materials such as e.g., tocopherols (vitamin E), tocotrienols, tocomonoenols, carotenoids, hydroxytyrosol, flavonols such as e.g., chrysin, quercetin, hesperidin, neohesperidin, naringin, morin, camphor oil, fisetin, anthocyanins such as e.g., delphinidin and malvidin, curcumin, carnosic acid, carnosol, rosmarinic acid, and resveratroluride tannins.

According to a further preferred embodiment, component (A) and component (B) are introduced into the plastic containing at least one transition metal in a weight ratio of from 90:10 to 10:90, preferably from 80:20 to 20:80, particularly preferably from 70:30 to 30:70.

Components (A) and (B) may be introduced into the plastic containing at least one transition metal, for example, in that components (A) and (B), which are present in solid or liquid form, are mixed with the plastic containing at least one transition metal, which is present as a solid, and the resulting mixture is melted and then cooled, or in that components (A) and (B), which are present in solid or liquid form, are melted and the resulting melt is introduced into a melt of the plastic containing at least one transition metal.

It is preferred here if 0.01 to 5.0 parts by weight, preferably 0.02 to 1.0 parts by weight, of the at least one sugar alcohol (component (A)) are introduced, relative to 95.0 to 99.99 parts by weight, preferably 99.0 to 99.98 parts by weight, of the plastic containing at least one transition metal.

It is in particular advantageous if, relative to 91 to 99.94 parts by weight, preferably 98.5 to 99.91 parts by weight, of the plastic containing at least one transition metal,
(A) 0.02 to 3 parts by weight, preferably 0.03 to 0.5 parts by weight, of at least one sugar alcohol, and
(B) 0.04 to 6 parts by weight, preferably 0.06 to 1 parts by weight, of at least one phenolic antioxidant are introduced.

The plastic containing at least one transition metal may be selected here from the group consisting of
a) polymers of olefins or diolefins, such as polyethylene, in particular LDPE, LLDPE, VLDPE, ULDPE, MDPE, HDPE and UHMWPE, metallocene-PE (m-PE), polypropylene, polyisobutylene, poly-4-methyl-pentene-1, polybutadiene, polyisoprene, polycyclooctene, polyalkylene-carbon monoxide copolymers, as well as corresponding copolymers in the form of random or block structures, such as polypropylene-polyethylene (EP), EPM or EPDM, ethylene-vinyl acetate (EVA), ethylene acrylic ester, such as ethylene-butyl acrylate, ethylene-acrylic acid-glycidyl acrylate, and corresponding graft polymers such as polypropylene-graft-maleic anhydride, polypropylene-graft-acrylic acid, polyethylene-graft-acrylic acid, polyethylene-polybutyl acrylate-graft-maleic anhydride as well as blends such as LDPE/LLDPE or also long-chain branched polypropylene copolymers produced with alpha-olefins as comonomers, for example with 1-butene, 1-hexene, 1-octene or 1-octadecene,
b) polystyrene, polymethylstyrene, polyvinylnaphthalene, styrene-butadiene (SB), styrene-butadiene-styrene (SBS), styrene-ethylene-butylene-styrene (SEBS), styrene-ethylene-propylene-styrene, styrene isoprene, styrene-isoprene-styrene (SIS), styrene-butadiene-acrylonitrile (ABS), styrene-acrylonitrile-acrylate (ASA), styrene-ethylene, styrene-maleic anhydride polymers including corresponding graft copolymers such as styrene on butadiene, maleic anhydride on SBS or SEBS, as well as graft copolymers of methyl methacrylate, styrene butadiene and ABS (MABS), and xalso hydrogenated polystyrene derivatives, such as polyvinyl cyclohexane,
c) halogen-containing polymers such as polyvinyl chloride (PVC), polychloroprene and polyvinylidene chloride (PVDC), copolymers of vinyl chloride and vinylidene chloride or of vinyl chloride and vinyl acetate, chlorinated polyethylene, polyvinylidene fluoride, epichlorohydrin- homo- and copolymers in particular with ethylene oxide (ECO),
d) polymers of unsaturated esters such as polyacrylates and polymethacrylates such as polymethyl methacrylate (PMMA), polybutyl acrylate, polylauryl acrylate; polystearyl acrylate; polyglycidyl acrylate, polyglycidyl methacrylate, polyacrylonitrile, polyacrylamides, copolymers such as polyacrylonitrile-polyalkyl acrylate,
e) polymers of unsaturated alcohols and derivatives, such as polyvinyl alcohol, polyvinyl acetate, polyvinyl butyral, polyallyl phthalate, polyallyl melamine,
f) polyacetals, such as polyoxymethylene (POM), and corresponding copolymers, such as copolymers with butanal,
g) polyphenylene oxides and blends of these with polystyrene or polyamides,
h) polymers of cyclic ethers, such as polyethylene glycol, polypropylene glycol, polyethylene oxide, polypropylene oxide, polytetrahydrofuran,
i) polyurethanes, from hydroxy-terminated polyethers or polyesters and aromatic or aliphatic isocyanates, such as 2,4- or 2,6-toluene diisocyanate or methylene diphenyl diisocyanate, in particular also linear polyurethanes (PU), polyureas,
j) polyamides such as polyamide 6, 6.6, 6.10, 4.6, 4.10, 6.12, 10.10, 10.12, 12.12, polyamide 11, polyamide 12 and (partially) aromatic polyamides such as polyphthalamides, e.g., produced from terephthalic acid and/or isophthalic acid and aliphatic diamines such as hexamethylenediamine or m-xylylenediamine or from aliphatic dicarboxylic acids such as adipic acid or sebacic acid and aromatic diamines such as hexamethylenediamine or m-xylylenediamine or from aliphatic dicarboxylic acids such as adipic acid or sebacic acid and aromatic diamines such as 1,4- or 1,3-diaminobenzene, blends of different polyamides such as PA-6 and PA 6.6 or blends of polyamides and polyolefins such as PA/PP,
k) polyimides, polyamideimides, polyetherimides, polyesterimides, poly(ether)ketones, polysulfones, polyethersulfones, polyarylsulfones, polyphenylene sulfides, polybenzimidazoles, polyhydantoins,
l) polyesters of aliphatic or aromatic dicarboxylic acids and diols or of hydroxy-carboxylic acids, such as polyethylene terephthalate (PET), polybutylene terephthalate (PBT), polypropylene terephthalate, polyethylene naphthylate, poly-1,4-dimethylolcyclohexane terephthalate, polyhydroxybenzoate, polyhydroxynaphthalate, polylactic acid, polyhydroxybutyrate (PHB), polyhydroxyvalerate (PHV), polyethylene succinate, polytetramethylene succinate, polycaprolactone,
m) polycarbonates, polyester carbonates, as well as blends of these, such as PC/ABS, PC/PBT, PC/PET/PBT, PC/PA,
n) cellulose derivatives such as cellulose nitrate, cellulose acetate, cellulose propionate, cellulose butyrate,
o) epoxy resins, consisting of di- or polyfunctional epoxy compounds in combination with, for example, hardeners based on amines, anhydrides, dicyandiamide, mercaptans, isocyanates or catalytically active hardeners,
p) phenolic resins such as phenol-formaldehyde resins, urea-formaldehyde resins, melamine-formaldehyde resins,
q) unsaturated polyester resins from unsaturated dicarboxylic acids and diols with vinyl compounds, for example styrene, alkyd resins,
r) silicones, for example based on dimethylsiloxanes, methyl-phenyl-siloxanes or diphenylsiloxanes, for example vinyl-group-terminated,
s) and mixtures, combinations or blends of two or more of the aforementioned polymers.

If the polymers specified under a) to r) are copolymers, they may be in the form of random, block or tapered structures. Furthermore, the mentioned polymers may be present in the form of linear, branched, star-shaped or hyper-branched structures.

It is particularly preferable for the plastic containing at least one transition metal to be constituted by polymers of olefins or diolefins, very particularly preferably polyethylenes or polypropylenes, for example.

If the polymers specified under a) to r) are stereoregular polymers, they may be in the form of isotactic, stereotactic, but also atactic forms or as stereoblock copolymers.

Furthermore, the polymers specified under a) to r) may have both amorphous and (partially) crystalline morphologies.

If necessary, the polyolefins mentioned under a) may also be cross-linked, for example cross-linked polyethylene, which is then called X-PE.

Furthermore, the present compounds may be used to stabilize rubbers and elastomers. These may be natural rubber (NR) or synthetic rubber materials. Suitable synthetic rubber materials consist in particular of butadiene (BR), styrene-butadiene (SBR), chloroprene (CR), isoprene (IR), isobutylene-isors, acrylonitrile-butadiene (NBR or in hydrogenated form HNBR). Other suitable rubbers and elastomers are ethylene-propylene-diene terpolymers (EPDM) and ethylene-propylene copolymers (EPM), polyester urethanes (AU), polyether urethanes (EU) and silicones (MQ).

In addition to virgin material, the plastics may be recycled plastics, e.g., from industrial collections such as production waste or plastics from household or recyclable material collections.

It is also possible that, during the method, at least one further additive, selected from the group consisting of aminic antioxidants, secondary antioxidants, in particular phosphites, phosphonites or thioethers, UV absorbers, light stabilizers, in particular the hindered amines as light (HALS) and long-term heat stabilizers (HAS), metal deactivators, filler deactivators, antiozonants, nucleating agents, antinucleating agents, transparency improvers (clarifiers), impact modifiers, plasticizers, lubricants, rheology or viscosity modifiers, thixotropic agents, chain extenders, processing aids, demolding aids, flame retardants, pigments, dyes, optical brighteners, antimicrobial agents, antistatic agents, slip agents, antiblocking agents, coupling agents, crosslinking agents, anti-crosslinking agents, hydrophilizing agents, hydrophobicizing agents, surface modifiers, hydrolysis stabilizers, adhesion promoters, dispersing agents, compatibilizers, oxygen scavengers, acid scavengers, acetaldehyde and formaldehyde scavengers, blowing agents, degradation additives (prodegradants), defoaming agents, odor scavengers, odor-improving substances, PVC heat stabilizers, marking agents, antifogging agents, gloss improvers, mattifying agents, additives for increasing the electrical and/or thermal conductivity, repellents, fillers and reinforcing agents and mixtures hereof, is introduced to the plastic containing at least one transition metal.

In a further preferred embodiment, the compositions contain secondary antioxidants, in particular phosphites/phosphonites, acid scavengers, costabilizers and/or light stabilizers from the group of hindered amines (HALS).

The present invention also relates to a plastics composition containing or consisting of at least one sugar alcohol (component (A)) and at least one phenolic antioxidant (component (B)), at least one plastic containing a transition metal selected from the group consisting of the metals of groups 6, 7, 8, 9, 10 and 11 of the periodic table, wherein the total content of the transition metals in the plastic composition is at least 10 ppm (wt./wt.).

The preferred embodiments described above with regard to the method, in particular the quantity and quality of the respective components, also apply without restriction for the purposes of defining the plastics composition according to the invention.

According to a preferred embodiment, the plastics composition contains or consists of 0.02 to 3.0 parts by weight, preferably 0.03 to 0.5 parts by weight, of the at least one sugar alcohol (component (A)), 0.02 to 3.0 parts by weight, preferably 0.03 to 0.5 parts by weight, of the at least one phenolic antioxidant (component (B)), and 94.0 to 99.96 parts by weight, preferably 99.0 to 99.94 parts by weight, of the at least one plastic containing a transition metal.

The plastics composition may also contain at least one further additive selected from the group consisting of aminic antioxidants, secondary antioxidants, in particular phosphites, phosphonites or thioethers, UV absorbers, light stabilizers, in particular the hindered amines as light (HALS) and long-term heat stabilizers (HAS), conventional metal deactivators, filler deactivators, antiozonants, nucleating agents, antinucleating agents, transparency improvers (clarifiers), impact modifiers, plasticizers, lubricants, rheology or viscosity modifiers, thixotropic agents, chain extenders, processing aids, demolding aids, flame retardants, pigments, dyes, optical brighteners, antimicrobial agents, antistatic agents, slip agents, antiblocking agents, coupling agents, crosslinking agents, anti-crosslinking agents, hydrophilizing agents, hydrophobicizing agents, surface modifiers, hydrolysis stabilizers, adhesion promoters, dispersing agents, compatibilizers, oxygen scavengers, acid scavengers, acetaldehyde and formaldehyde scavengers, blowing agents, degradation additives (prodegradants), defoaming agents, odor scavengers, odor-improving substances, PVC heat stabilizers, marking agents, antifogging agents, gloss improvers, mattifying agents, additives for increasing the electrical and/or thermal conductivity, repellents, fillers and reinforcing agents and mixtures hereof.

The invention also relates to a molding compound or a molded part producible from a plastics composition according to the invention as described above. Molded parts are selected in particular from molded parts produced by injection molding, for example, bottles, containers, screw-top vessels, crates, barrels, buckets, pallets, technical parts for cars and transport such as bumpers, trim parts, handles, headlight covers, fittings and functional parts, electrical and electronic applications such as housing parts and accessories for televisions, computers, mobile phones, washing machines, dishwashers, coffee machines, drills, plug connections, storage media, household, leisure and sporting articles such as planters, clothes hangers, toy figures, model making parts, components for furniture such as brackets and clips, parts produced by blow molding, in particular hollow bodies such as bottles, fuel tanks, canisters, washing water tanks and expansion tanks, parts produced by rotational molding, in particular tanks such as fuel oil tanks, and rainwater tanks, housings for machines, transport containers, leisure and water sports articles, such as kayaks, parts produced by calendering, in particular films such as decorative films, wallpapers and floor coverings, parts produced by additive manufacturing processes, for example parts produced by binder jetting (BJ), laser sintering (LS), selective laser melting (SLM), electron beam melting (EBM), fused deposition modeling (FDM), fused filament fabrication (FFF), multi-jet modeling (MJM), poly-jet modeling (PJM), layer laminated manufacturing (LLM), thermal transfer sintering (TTS), digital light processing (DLP), photopolymer jetting (PJ) and stereolithography (SL).

The present invention is suitable in particular for the stabilization of plastics in the form of injection-molded parts, sheets or films, foams, fibers, cables and tubes, profiles, hollow bodies, tapes, membranes, such as geomembranes, or adhesives, which are produced via extrusion, injection molding, blow molding, calendering, pressing methods, spinning processes, rotomolding, for example
for packaging, for example for food, detergents, cosmetics, adhesives in the form of films, bottles, bags, screw-top vessels,
storage and transport containers such as boxes, crates, barrels, buckets, pallets,
automotive, railway, aircraft, ship and machine parts, such as bumpers, trim parts, fittings and functional parts, upholstery,
construction applications such as profiles, construction sheets, cable ducts, house cladding, noise barriers, drainage channels, profiled boards, floor coverings,
road and landscaping applications such as beacon bases, posts, barriers, geotextiles,
electrical and electronic applications such as housing parts and accessories of televisions, computers, mobile phones, washing machines, dishwashers, coffee machines, drills, connectors, storage media,
cable insulation,
pipes for, for example, water, gas, sewage, irrigation, drainage pipes; hygiene products, such as diapers,
furniture and textile applications, such as curtains and cushions, worktops,
household, leisure and sporting articles such as balls, tennis rackets, skis, flower pots, rain barrels, clothes hangers,
agricultural applications such as mulch, tunnel or perforated films, plant pots,
pharmaceutical and crop protection applications such as encapsulation of active ingredients and biologically active substances.
In medical technology for the production of suture material, bandages, orthoses and prostheses.

Furthermore, the present invention relates to the use of at least one sugar alcohol (component (A)) in combination with at least one phenolic antioxidant (component (B)) for stabilizing plastics containing at least one transition metal against oxidative, thermal and/or actinic degradation, wherein an additivation of the at least one sugar alcohol (component (A)) and the at least one phenolic antioxidant (component (B)) to the plastic containing at least one transition metal selected from the group consisting of the metals of groups 6, 7, 8, 9, 10 and 11 of the periodic table is carried out, so that the total content of the transition metals in the resulting plastics composition is at least 10 ppm (wt./wt.).

The present invention may be carried out, for example, by means of an additive composition consisting of at least one sugar alcohol (component (A)) and at least one phenolic antioxidant (component (B)), by mixing this additive composition, which may be present as a powder, liquid, oil, compacted, on a carrier material, as granules, solution or flakes, with the polymer to be stabilized, transferring the polymer matrix into the melt and then cooling it. Alternatively, it is also possible to introduce the additive into a polymer melt in a molten state.

In the event that further components are added to the polymer composition, these may be added to the polymers separately, in the form of liquids, powders, granules or compacted products, or together with the additive composition according to the invention as described above.

The incorporation of the additive composition described above and, if necessary, the additional additives into the plastic is carried out by conventional processing methods, preferably by mixers, kneaders or extruders. Preferred processing machines are extruders, such as single-screw extruders, twin-screw extruders, planetary roller extruders, ring extruders, and co-kneaders, which are preferably equipped with vacuum degassing. The processing may take place here under air or, if necessary, under inert gas conditions.

The plastics compositions containing the described additive composition may be processed by conventional plastics processing methods in continuous and discontinuous processes, such as extrusion, calendering, blow molding, pultrusion, injection molding, pressing, transfer molding, casting, blow molding, rotational molding, thermoforming, sintering, foaming or also by additive manufacturing processes for the production of granular material, molded parts, semi-finished products, fibers and films.

Suitable extruders are piston extruders and screw extruders, single-screw extruders, twin-screw extruders, multi-screw extruders, planetary roller extruders, in particular for the production of plastics granular materials, pipes, rods, tubes, profiles, sheathing, board, films, V-belts, toothed belts, seals, foam boards (XPS), fibers and filaments for additive manufacturing processes.

Suitable injection-molding machines may be hydraulic or electromechanical and may comprise multi-component injection-molding and in-mold processes.

Molded parts produced by injection molding are, for example, bottles, containers, screw-top vessels, crates, barrels, buckets, pallets, technical parts for cars and transport such as bumpers, trim parts, handles, headlight covers, fittings and functional parts, electrical and electronic applications such as housing parts and accessories for televisions, computers, mobile phones, washing machines, dishwashers, coffee machines, drills, plug connections, storage media, household, leisure and sporting articles such as planters, clothes hangers, toy figures, model making parts, components for furniture such as brackets and clips.

Parts produced by blow molding are in particular hollow bodies such as bottles, fuel tanks, canisters, washing water tanks and expansion tanks.

Parts produced by rotational molding are in particular tanks such as fuel oil tanks, and rainwater tanks, housings for machines, transport containers, leisure and water sports articles, such as kayaks.

Calendering is used in particular to produce films such as decorative films, wallpapers and floor coverings.

Furthermore, the additive compositions according to the invention may be prepared and incorporated in the form of so-called masterbatches or concentrates containing, for example, 10-90% of the compositions according to the invention in a polymer or a polymer recyclate.

The present invention is explained in more detail with reference to the following exemplary embodiments, without limiting the invention thereto.

### EXEMPLARY EMBODIMENTS

To test the effect of the stabilizers according to the invention, a commercially available polypropylene (Moplen HP 500N, Lyondell Basell Industries) was homogenized in a powder-powder mixture with the stabilizers according to the invention and circulated in a twin-screw microextruder (MC 5, manufacturer DSM) for 30 minutes at 200° C. and 90 rpm and the decrease in force was recorded. The force is a direct measure of the molecular weight of polypropylene: the lower the decrease, the higher the stabilizing effect.

| | | Force retention |
|---|---|---|
| | | after 10/20/30 |
| Example | Additive | minutes [%] |
| Comparative | without | 85/66/46 |
| example 1 | | |
| Comparative | 0.01% iron(III) chloride | 63/40/23 |
| example 2 | | |
| Comparative | 0.05% iron(II) chloride | 73/44/26 |
| example 3 | | |
| Comparative | 0.05% iron(II) stearate | 58/34/19 |
| example 4 | | |
| Comparative | 0.05% copper(II) chloride | 77/50/32 |
| example 5 | | |
| Comparative | 0.01% manganese(IV) oxide | 82/58/36 |
| example 6 | | |
| Comparative | 0.05% manganese(IV) oxide | 81/53/32 |
| example 7 | | |
| Example 1 | 0.05% iron(II) chloride + 0.15% | 87/90/92 |
| | erythritol + 0.15% AO-1 | |
| Example 2 | 0.05% copper(II) chloride + | 90/89/92 |
| | 0.15% erythritol + 0.15% AO-1 | |
| Example 3 | 0.01% iron(II) chloride + 0.1% | 96/96/93 |
| | AO-1 + 0.1% erythritol | |
| Example 4 | 0.01% copper(II) chloride + 0.1% | 92/92/90 |
| | AO-1 + 0.1% erythritol | |
| Example 5 | 0.01% iron(II, III) oxide + 0.1% | 94/92/90 |
| | AO-1 + 0.1% erythritol | |
| Example 6 | 0.01% copper(II) chloride + 0.1% | 94/94/92 |
| | AO-2 + 0.2% erythritol | |
| Example 7 | 0.01% copper(II) chloride + 0.1% | 95/95/95 |
| | AO-3 + 0.2% erythritol | |
| Example 8 | 0.01% copper(II) chloride + | 92/90/88 |
| | 0.05% AO-4 + 0.2% erythritol | |
| Example 9 | 0.01% copper(II) chloride + 0.1% | 92/92/90 |
| | AO-1 + 0.2% mannitol | |
| Example 10 | 0.01% copper(II) chloride + 0.1% | 92/92/90 |
| | AO-1 + 0.2% myo-inositol | |

AO-2: ethylene-1,2-bis(3,3-bis[3-tert-butyl-4-hydroxyphenyl]butyrate (Hostanox 03, Clariant SE)

AO-3: 1,3,5-trimethyl-2,4,5-tris(3′,5′-di-tert-butyl)-4′-hydroxybenzyl)-benzene (Irganox 1330, BASF SE)

AO-4: 2′,3-bis[[3-[3,5-di-tert-butyl-4-hydroxyphenyl]propionyl]]proponiohydrazine (Irganox MD 1024, BASF SE).

The addition of transition metals leads to a significant deterioration in the stability of polypropylene (Comparative Examples 2-7); with the additives according to the invention, no degradation of the polypropylene is observed even after 30 minutes, i.e., there is an excellent stabilizing effect.

1-19. (canceled)

20. A method for stabilizing a plastic containing at least one transition metal against oxidative, thermal and/or actinic degradation, in which at least one sugar alcohol (component (A)) and at least one phenolic antioxidant (component (B)) are introduced into the plastic containing at least one transition metal selected from the group consisting of the metals of groups 6, 7, 8, 9, 10 and 11 of the periodic table, such that the total content of the transition metal or metals in the resulting plastics composition is at least 10 ppm (wt./wt.).

21. The method according to claim 20, wherein the total content of the transition metal or metals in the resulting plastics composition is at least 50 ppm (wt./wt.) ppm.

22. The method according to claim 20, wherein the at least one transition metal is selected from the group consisting of Fe, Co, Ni, Cu, Cr, and Mn.

23. The method according to claim 20, wherein the metals of groups 4, 5 and 6 of the periodic table are excluded from the definition of the at least one transition metal.

24. The method according to claim 20, wherein the at least one sugar alcohol is selected from the group consisting of alditols and cyclitols.

25. The method according to claim 24, wherein the alditol has the empirical formula HOCH₂[CH(OH)]ₙCH₂OH, R₁—OCH₂[CH(OH)]ₙCH₂OH, or HOCH₂[CH(OH)]˜[CH(OR₁)]CH₂OH, wherein n=2-6, and wherein R₁ is an optionally substituted sugar residue.

26. The method according to claim 24, wherein the alditol is selected from the group consisting of threitol, erythritol, galactitol, mannitol, ribitol, sorbitol, xylitol, arabitol, isomalt, lactitol, maltitol, altritol, iditol, maltotritol and hydrogenated oligo- and polysaccharides with polyol end groups and mixtures thereof, heptitols, and octitols.

27. The method according to claim 26, wherein the heptitol is selected from the group consisting of meso-glyceroallo-heptitol, D-glycero-D-altro-heptitol, D-glycero-D-manno-heptitol, meso-glycero-gulo-heptitol, D-glycero-D-galacto-heptitol (perseitol), D-glycero-D-gluco-heptitol, L-glycero-D-gluco-heptitol, D-erythro-L-galacto-octitol, and D-threo-L-galacto-octitol.

28. The method according to claim 24, wherein the cyclitol is selected from the group consisting of inositol (myo, scyllo-, D-chiro-, L-chiro-, muco-, neo-, allo-, epi- and cis-inositol), 1,2,3,4-tetrahydroxycyclohexane, 1,2,3,4,5-pentahydroxycyclohexane, quercitol, viscumitol, bornesitol, conduritol, ononitol, pinitol, pinpollitol, quebrachitol, ciceritol, quinic acid, shikimic acid, and valienol.

29. The method according to claim 20, wherein component (A) and component (B) are introduced into the plastic containing at least one transition metal in a weight ratio of from 90:10 to 10:90.

30. The method according to claim 20, wherein components (A) and (B) are introduced into the plastic containing at least one transition metal in that
components (A) and (B), which are present in solid or liquid form, are mixed with the plastic present as a solid and containing at least one transition metal and the resulting mixture is melted and cooled, or
components (A) and (B), which are present in solid or liquid form, are melted and the resulting melt is introduced into a melt of the plastic containing at least one transition metal.

31. The method according to claim 20, wherein 0.01 to 5.0 parts by weight of the at least one sugar alcohol (component (A)) are introduced relative to 95.0 to 99.99 parts by weight of the plastic containing at least one transition metal.

32. The method according to claim 20, wherein relative to 91 to 99.94 parts by weight of the plastic containing at least one transition metal,
(A) 0.02 to 3 parts by weight of at least one sugar alcohol, and
(B) 0.04 to 6 parts by weight of at least one phenolic antioxidant are introduced.

33. The method according to claim 20, wherein the plastic containing at least one transition metal is selected from the group consisting of
a) polymers of olefins or diolefins and polyalkylene-carbon monoxide copolymers,
b) polystyrene, polymethylstyrene, polyvinylnaphthalene, styrene-butadiene (SB), styrene-butadiene-styrene (SBS), styrene-ethylene-butylene-styrene (SEBS), styrene-ethylene-propylene-styrene, styrene isoprene, styrene-isoprene-styrene (SIS), styrene-butadiene-acrylonitrile (ABS), styrene-acrylonitrile-acrylate (ASA), styrene-ethylene, and styrene-maleic anhydride polymers including corresponding graft copolymers,
c) halogen-containing polymers,
d) polymers of unsaturated esters; polyglycidyl acrylate, polyglycidyl methacrylate, polyacrylonitrile, polyacrylamides, and polyacrylonitrile-polyalkyl acrylate,
e) polymers of unsaturated alcohols and derivatives, and polyallyl melamine,
f) polyacetals and corresponding copolymers thereof,
g) polyphenylene oxides and blends of these with polystyrene or polyamides,
h) polymers of cyclic ethers,
i) Polyurethanes and polyureas,
j) Polyamides,
k) polyimides, polyamideimides, polyetherimides, polyesterimides,
poly(ether)ketones, polysulfones, polyethersulfones, polyarylsulfones, polyphenylene sulfides, polybenzimidazoles, and polyhydantoins,
l) polyesters of aliphatic or aromatic dicarboxylic acids and diols or of hydroxy-carboxylic acids,
m) polycarbonates, polyester carbonates, as well as blends of these,
n) cellulose derivatives,
o) epoxy resins,
p) phenolic resins, urea-formaldehyde resins, and melamine-formaldehyde resins,
q) unsaturated polyester resins from unsaturated dicarboxylic acids and diols with vinyl compounds,
r) silicones, and
s) and mixtures, combinations or blends of two or more of the aforementioned polymers.

34. The method according to claim 20, wherein the plastic containing at least one transition metal contains at least one further additive selected from the group consisting of aminic antioxidants, secondary antioxidants, UV absorbers, light stabilizers, metal deactivators, filler deactivators, antiozonants, nucleating agents, antinucleating agents, transparency improvers or clarifiers, impact modifiers, plasticizers, lubricants, rheology or viscosity modifiers, thixotropic agents, chain extenders, processing aids, demolding aids, flame retardants, pigments, dyes, optical brighteners, antimicrobial agents, antistatic agents, slip agents, antiblocking agents, coupling agents, crosslinking agents, anti-crosslinking agents, hydrophilizing agents, hydrophobicizing agents, surface modifiers, hydrolysis stabilizers, adhesion promoters, dispersing agents, compatibilizers, oxygen scavengers, acid scavengers, acetaldehyde and formaldehyde scavengers, blowing agents, degradation additives or prodegradants, defoaming agents, odor scavengers, odor-improving substances, PVC heat stabilizers, marking agents, antifogging agents, gloss improvers, mattifying agents, additives for increasing the electrical and/or thermal conductivity, repellents, fillers, reinforcing agents, and/or the at least one further additive is incorporated during into the plastic containing at least one transition metal.

35. A plastics composition containing
at least one sugar alcohol (component (A)), at least one phenolic antioxidant (component (B)), and at least one plastic containing a transition metal selected from the group consisting of the metals of groups 6, 7, 8, 9, 10, and 11 of the periodic table, wherein the total content of the transition metals in the plastic composition is at least 10 ppm (wt./wt.).

36. The plastics composition according to claim 35, wherein the plastic composition contains
0.02 to 3.0 parts by weight of the at least one sugar alcohol(component (A)),
0.02 to 3.0 parts by weight of the at least one phenolic antioxidant (component (B)), and
94.0 to 99.96 parts by weight of the at least one plastic containing a transition metal selected from the group consisting of the metals of groups 6, 7, 8, 9, 10 and 11 of the periodic table.

37. The plastics composition according to claim 35, wherein the at least one further additive is selected from the group consisting of aminic antioxidants, secondary antioxidants, UV absorbers, light stabilizers, metal deactivators, filler deactivators, antiozonants, nucleating agents, antinucleating agents, transparency improvers or clarifiers, impact modifiers, plasticizers, lubricants, rheology or viscosity modifiers, thixotropic agents, chain extenders, processing aids, demolding aids, flame retardants, pigments, dyes, optical brighteners, antimicrobial agents, antistatic agents, slip agents, antiblocking agents, coupling agents, crosslinking agents, anti-crosslinking agents, hydrophilizing agents, hydrophobicizing agents, surface modifiers, hydrolysis stabilizers, adhesion promoters, dispersing agents, compatibilizers, oxygen scavengers, acid scavengers, acetaldehyde scavengers, formaldehyde scavengers, blowing agents, degradation additives or prodegradants, defoaming agents, odor scavengers, odor-improving substances, PVC heat stabilizers, marking agents, antifogging agents, gloss improvers, mattifying agents, additives for increasing the electrical and/or thermal conductivity, repellents, fillers, and reinforcing agents.

38. A molding compound or molded part produced from a plastics composition according to claim 35.

39. The molding compound or molded part according to claim 38, which is a molded part produced by injection molding, blow molding, rotational molding, calendering, or an additive manufacturing process.

40. The molded part according to claim 39, which is
(a) selected from the group consisting of bottles, containers, screw-top vessels, crates, barrels, buckets, pallets, technical parts for cars, bumpers, trim parts, handles, headlight covers, fittings, functional parts, parts for electrical or electronic applications, storage media, household, leisure and sporting articles model making parts, components for furniture, bottles, fuel tanks, canisters, washing water tanks, and expansion tanks,
(b) selected from the group consisting of tanks, housings for machines, transport containers, and leisure and water sports articles,
(c) selected from the group consisting of films, wallpapers, and floor coverings, or
(d) a part produced by binder jetting (BJ), laser sintering (LS), selective laser melting (SLM), electron beam melting (EBM), fused deposition modeling (FDM), fused filament fabrication (FFF), multi-jet modeling (MJM), poly-jet modeling (PJM), layer laminated manufacturing (LLM), thermal transfer sintering (TTS), digital light processing (DLP), photopolymer jetting (PJ), or stereolithography (SL).
